(19) United States
(12) Patent Application Publication
(10) Pub. No.: US 2009/0193024 A1
(43) Pub. Date: Jul. 30, 2009

(54) Metadata Based Navigation Method

(76) Inventor: Sudhanva Dhananjaya, Jayalakshmipuram (IN)

Correspondence Address: CENTRAL COAST PATENT AGENCY, INC, 3 HANGAR WAY SUITE D, WATSONVILLE, CA, 95076, US

(21) Appl. No.: 12/358,766

(22) Filed: Jan. 23, 2009

(30) Foreign Application Priority Data
Jan. 28, 2008 (IN) 231/CHE/2008

(51) Int. Cl. G06F 17/30; G06F 3/048; G06F 15/173

(52) U.S. Cl. 707/6; 709/225; 715/764; 707/3; 726/4; 707/E17.014; 707/E17.017; 707/E17.032

(57) ABSTRACT

The embodiments of present invention provide a metadata based navigation method for web based online learning platform that facilitates intelligent interactions and knowledge sharing among the users of the portal with compatible profiles and compatible learning spaces. The communication of authorized user in the network is limited to the learning spaces they are attached to. The authorized user can communicate and interact with other user only if both the users are part of one or more learning spaces. This ensures the efficient interaction among the users. The identity of any user is based on the learning spaces.

### CROSS-REFERENCE TO RELATED DOCUMENTS

The present application claims priority to Indian patent application serial number 231/CHE/2008, which was filed on Jan. 28, 2008, which is incorporated herein in its entirety, at least by reference.

### BACKGROUND

1. Technical field

The embodiments herein generally relate to navigation system in an online learning spaces based web portal. More particularly it relates to metadata based navigation method for the online learning spaces based web portal designed to improve communication and collaboration among a wide range of learning communities and users.

2. Description of the Related Art

The World Wide Web search engines have fundamentally transformed the way people share information. A new form of publishing and sharing information through online networking has become very popular. Web based networking portals and search engines have provided a more personalized, context-based, and interactive platform to publish, share and search information more efficiently as compared to literature or formal document search. In the pre-internet era information was localized and people were dependent on local and personal interactions among their trusted personal network. In today's internet era any and every information is just a mouse click away. Online web based networks have evolved as very effective tool for people to interact, communicate and share information among each other.

The online web based network system allows users to share information among their personal and professional network. Generic web portals, social networks, search engines generally lack information that is relevant in a context to the user who wants to use them. Many times user needs a personalized, on time, valuable, and trusted input on the subject he or she is querying or searching for. The inputs from the networks and search engines are huge but the relevance to the current context is much to be desired.

People today want to share and contribute more and more information among the online communities they are part of. They want to have simpler and global reach. People today want a platform that presents information from diverse sources in a unified way and improvises communication and collaboration among learners, customers, partners, and employees or in general, a wide range of learning communities.

A successful learning platform also requires an efficient navigation system in order to have better connectivity with other members and communities. In the many community portals, metadata are attached to learning space and user profile. The metadata is used to invite users to a group/community through automatic pattern match and search. The metadata attached to user profiles and group/community can be useful to navigate through different communities or user profiles.

It is very important to have an approach wherein user can be navigated through right efficient search and system should be intelligent enough to understand user's navigation perspective. Online platform that is used for facilitating intelligent interactions and knowledge sharing among the users and learning communities need very efficient interactions. The entire portal might consist of thousands of users but the user prefers to interact with user having similar interests or requirements. Online portals based on metadata based interaction and communication can be used for precise and efficient interaction.

Hence there is a need to develop a metadata based navigation method for the online web portal designed to improve communication and collaboration among a wide range of communities. There is a further need to provide a navigation system for web based online learning platform that facilitates intelligent interactions and knowledge sharing among the users of the portal with compatible profiles. There is a further need to provide a navigation system for web based online learning platform that facilitates intelligent interactions and knowledge sharing among the users and between user and learning communities.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concept of the invention in a simplified form as a prelude to the more detailed description that is presented later.

The embodiments of present invention provide a metadata based navigation method for authorized users of learning spaces so that authorized users can navigate through their learning space network they are linked with, their friends network they are connected with and the past activities and contributions in the learning spaces. The present invention further provides a metadata based navigation system for learning spaces to improve communication and collaboration among a wide range of learning communities and its members. Another object of the present invention is to provide a navigation system for web based online learning platform that facilitates intelligent interactions and knowledge sharing among the users of the portal with compatible profiles and compatible learning spaces.

The communication of authorized user in the network is limited to the learning spaces they are attached to. The authorized user can communicate and interact with other user only if both the users are part of one or more learning spaces. This ensures the efficient interaction among the users. The identity of any user is based on the learning spaces.

The authorized users of community portal can view their learning spaces network they are linked with, their friends network they are connected with, the past activities and contributions in the learning spaces and their ranking progress. The metadata provided by authorized user of community portal can be organization, role, name, email, date of birth, gender, address, country, state, city, contact number, interest, education, competencies, and keywords.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 shows three types of learning spaces and associated environment.

FIG. 2 illustrates communication and interaction environment in among authorized users in a learning space.

FIG. 3 illustrates interaction mechanism between two users connected through two learning spaces.

FIG. 4 shows flowchart of search engine functionalities.

FIG. 5 shows conceptual view of learning space network.

Although specific features of the present invention are shown in some drawings and not in others. This is done for convenience only as each feature may be combined with any or all of the other features in accordance with the present invention.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments of present invention provide a metadata based navigation method for authorized users of learning spaces so that authorized users can navigate through their learning space network they are linked with, their friends network they are connected with and the past activities and contributions in the learning spaces. The present invention further provides a metadata based navigation system for learning spaces to improve communication and collaboration among a wide range of learning communities and its members. Another object of the present invention is to provide a navigation system for web based online learning platform that facilitates intelligent interactions and knowledge sharing among the users of the portal with compatible profiles and compatible learning spaces.

Learning spaces based online community portal is designed to improve communication and collaboration among authorized users of a wide range of learning communities of the portal and further presenting and sharing the information from diverse sources in a unified way. The authorized user provides relevant information about himself and other related parameters in form of metadata. The authorized user can also create collaborative learning space based on the preference and administrative privileges provided to the user. Three types of learning spaces can be created: a) open learning space; b) profile based learning space; c) content based learning space. There can be any number of learning spaces (virtual spaces) where users can interact and collaborate. Only authenticated/authorized users have entries to the system. Authorized users can create learning spaces based on their privileges. Once the learning space is created, the creator becomes owner of the learning space. The user is provided with the compendium of Web tools such as Blog, Wiki, RSS Feeds, discussion forum, Podcast and other collaboration tools for the learning space. Using metadata the user/owner of learning space can invite similar profile users to the learning space through automatic pattern match and search. The pattern match and search is conducted between metadata of the learning space and metadata of the authorized users. Participants of learning space can build information space by contributing contents, posting views/queries and comments, rating artifacts, subscribing news and audio/video materials in the learning space. Each user's privileges are decided by creator of the learning space.

The creator of the learning space becomes owner of learning space. The owner of the learning space can upload and share documents with other users of the learning space. The user of the learning space can upload and share documents with other users of the learning space based on privileges provided to the user by the owner of the learning space.

Most common metadata used are: a) topic in scope—topics that are in scope of the learning space collaboration for e.g. the learning space secondary school mathematics deals with Algebra, Trigonometry, Calculus etc. b) topic out of scope—topics that are not in the scope of learning space collaboration for e.g. the learning space secondary school Mathematics does not deal with advanced Mathematics such as Vectors and Functions. c) prerequisites—prerequisites that are required to become a member of the learning spaces. d) learning objectives—objectives of the learning space. e) prior learning—prior learning expected to become a learning space member. e) skills—skills expected to become a learning space member. f) age range—member should be within the specified age range. g) country—member should belong to the specified country. h) educational level—member should satisfy the education level specified.

The communication of authorized user in the network is limited to the learning spaces they are attached to. The authorized user can communicate and interact with other user only if both the users are part of one or more learning spaces. This ensures the efficient interaction among the users. The identity of any user is based on the learning spaces.

The authorized users of community portal can view their learning spaces network they are linked with, their friends network they are connected with, the past activities and contributions in the learning spaces and their ranking progress. The metadata provided by said authorized user of community portal can be organization, role, name, email, date of birth, gender, address, country, state, city, contact number, interest, education, competencies, and keywords.

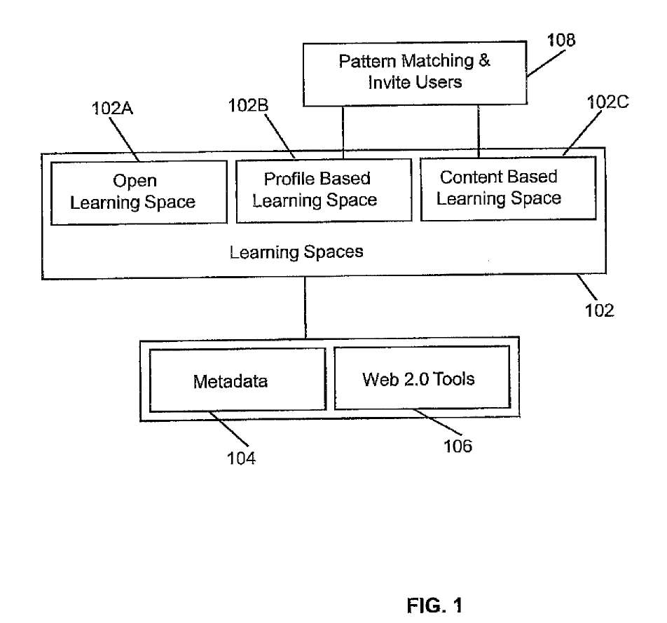

FIG. 1 shows three types of learning spaces 102. Learning spaces 102 are personalized user interaction spaces providing a pathway to access enterprise contents, services and processes. All Web 2.0 services 106 and collaboration services come together as part of learning spaces. Three types of learning spaces that can be created are: Open learning space 102A; Profile based learning space 102B; Content based learning space 102C. Open learning spaces 102A are open to all the users of community portal. Interested users can register and become member of the learning spaces. In these types of learning spaces, learning space profile may be common interest for the users. For e.g. it could be current events, sports. All the three types of learning spaces are attached with learning space metadata 104 and Web 2.0 tools 106. In case of content based learning space 102C, content are mapped to the learning space. There can be any number of learning spaces (virtual spaces) where users can interact and collaborate. Only authenticated/authorized users have entries to the system.

Authorized users can create learning spaces based on their privileges. Once the learning space is created, the creator becomes owner of the learning space. The owner of the learning space can set the Web 2.0 tools privileges to the members of that learning space. Owner of the learning space himself is a moderator of the learning space; he can assign moderator privileges to one or more members of the learning space. In profile based learning spaces 102B in-depth collaboration is required e.g. it could be a secondary school Mathematics, Newton's third Law. Users are invited to the learning spaces based on pattern match and search 108. The matching is based on learning space profile with users' profile. Based on the search results, the creator of learning space can shortlist compatible profiles and send invites to the user to join the learning space. The advantage of this type of learning space is that the member's profiles are similar with the learning space profile and they can add more value to the discussions and collaborations.

In content based learning spaces 102C, profile of the learning spaces may be any content or course content. For e.g. it could be a course content of software engineering, metamorphosis etc. Like profile based Learning Space 102B, users' are invited through pattern match and search 108 by matching users profile with learning space profile. The creator of the learning space can import and map the content to the learning space and the members of the learning space are can access the same.

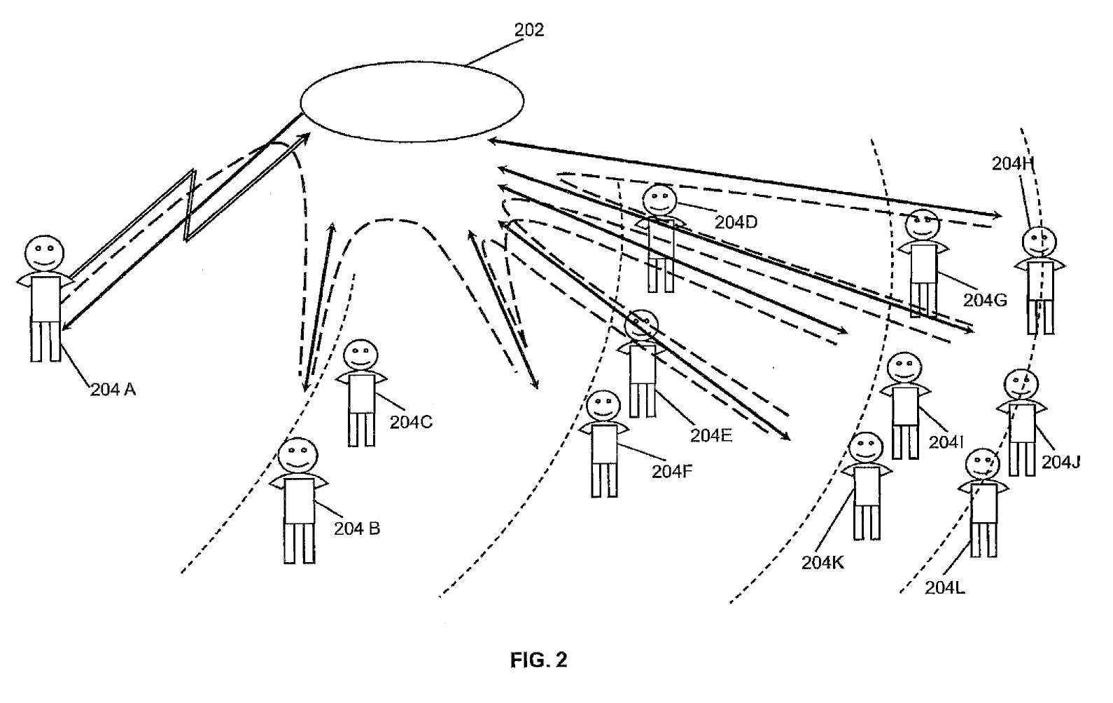

FIG. 2 illustrates interaction among users (204A-L) connected through common learning space (202). Authorized users (204A-L) can interact with the users (204A-L) who are having one or more than one common learning spaces 202 that exist in the network. Similarity considered is based on the common metadata exists in the community learning spaces. User network centric allows the members to view their personalized network. It provides the view of member's owned learning space, registered learning space and pending invites. Members can view other learning spaces, its member details and their contributions such as Web 2.0 tools, Artifacts etc. On selection of artifact, it facilitates easy navigation to the particular learning space view. My friends network provides a view of the member's friends Network. It is based on common learning spaces between them. It allows members to view common artifacts and their contributions.

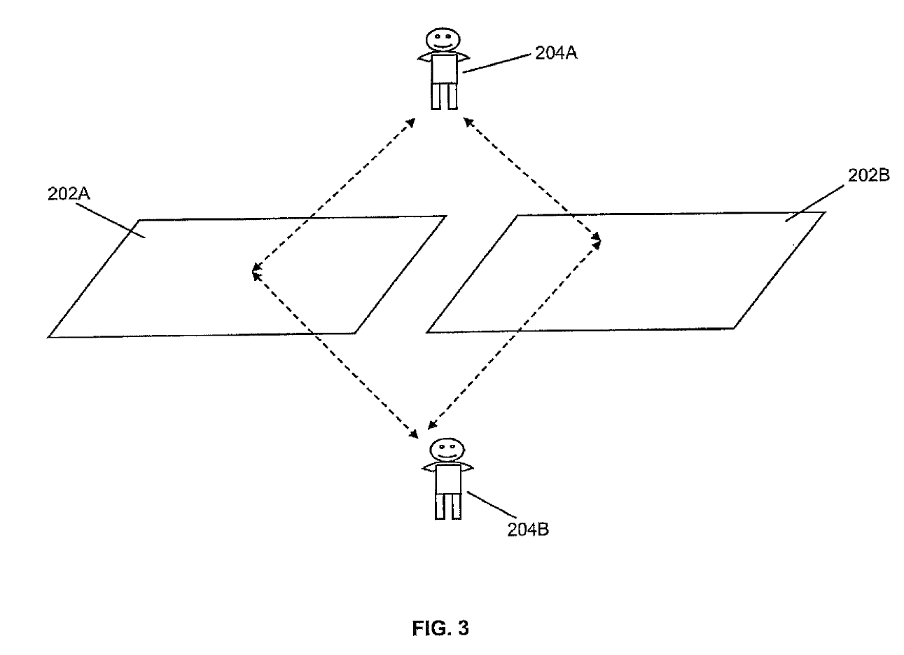

FIG. 3 illustrates interaction mechanism between two users 204A, 204B connected through two learning spaces 202A, 202B. The communication of authorized users 204A, 204B in the network is limited to the learning spaces 202A, 202B they are attached to. The authorized user 204A can communicate and interact with other user 204B only if both the users are part of common one or more learning spaces 202A, 202B. This ensures the efficient interaction among the users 204A, 204B. The identity of any user is based on the learning spaces.

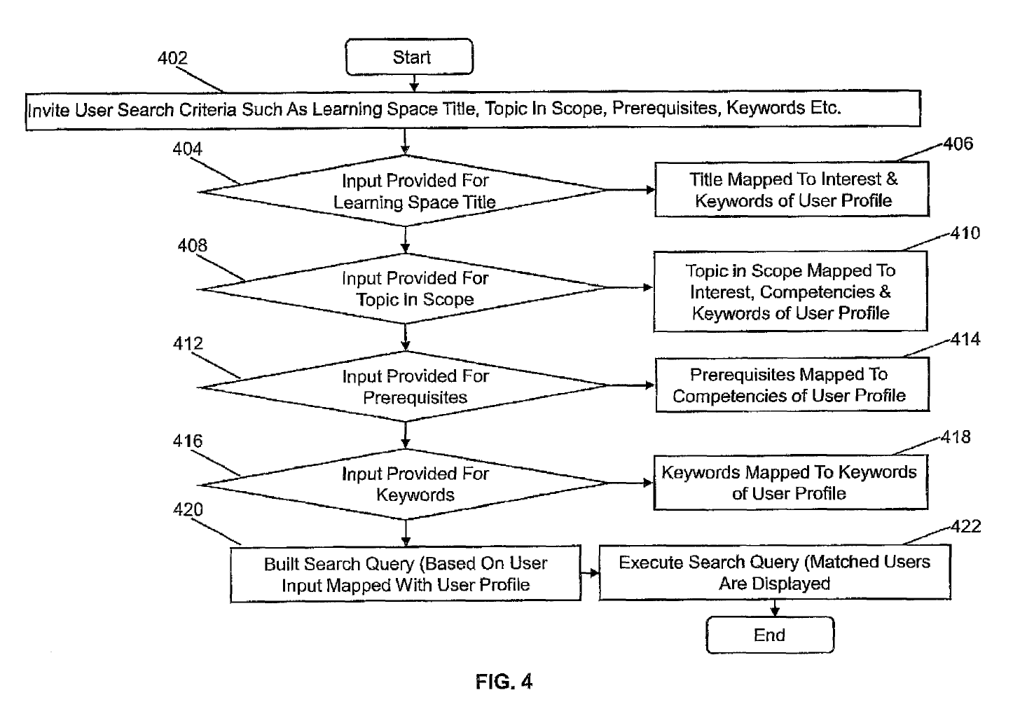

FIG. 4 shows flowchart of search engine functionalities. The portal has inbuilt intelligence of pattern matching and search which helps in the process of finding as many members' profile that are matched with learning space profile. This feature establishes meaningful communication and collaboration among the learning space members. Also, user can select required search criteria (metadata) for pattern matching and search. Once the pattern is matched, the search results are displayed. To invite users to learning space, the owner of the learning space can provide the required pattern match search criteria (metadata) (402) such as learning space title, topic in scope, prerequisites, skills, education level, age range, language, region and keywords. If learning space title is entered as search criteria (404), learning space title is mapped to interest and keywords of user profile (406). If learning space topic in scope is entered as search criteria (408), topic in scope is mapped to interest, competencies and keywords of user profile (410). If learning space prerequisites is entered as search criteria (412), prerequisites are mapped to competencies of user profile (414). If learning space education level is entered as search criteria, education level is mapped to education level of user profile. If learning space age range is entered as search criteria, age range is mapped to data of birth of user profile. If learning space region is entered as search criteria, region is mapped to the country of user profile. If learning space keywords is entered as search criteria (416), keywords are mapped to keywords of user profile (418). Search query is built based on the above search criteria entered (420) and executed and matched user profiles are displayed (422).

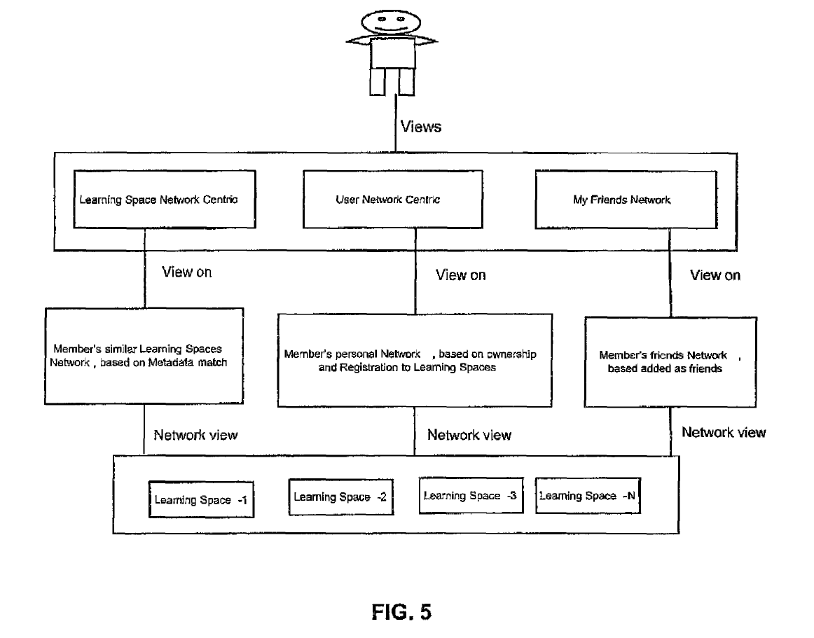

FIG. 5 shows conceptual view of learning space network. User network centric allows the members to view their personalized network. It provides the view of member's owned learning space, registered learning space and pending invites. Members can view other learning spaces, its member details and their contributions such as Web 2.0 tools, Artifacts etc. On selection of artifact, it facilitates easy navigation to the particular learning space view. My friends network provides a view of the member's friends Network. It is based on common learning spaces between them. It allows members to view friend's artifacts and their contributions.

What is claimed is:

1. Metadata based navigation method between authorized users of learning spaces based on common learning space, so that the authorized users can view their learning spaces network they are linked with, their friends network they are connected with and the activities and contributions in the learning spaces, wherein identity of authorized user in the network is based on the learning spaces they are attached to. The method comprising of:
collecting and storing information of authorized user in form of metadata, wherein based on metadata authorized users are invited to join learning spaces in the network;
providing pattern match and search mechanism among users based on metadata;
providing pattern match and search mechanism among users and learning communities based on metadata; and
providing graphical navigation mechanism between two users based on common learning space they are connection to, wherein said navigation mechanism utilizes metadata for providing navigation roadmap between the users; wherein user's interaction between other users of the network is only based on the common learning spaces they are attached to.

2. The method of claim 1, wherein the online learning space is a community portal comprises of wide range of learning communities.

3. The method of claim 1, wherein the learning community is created by authorized users of community portal.

4. The method of claim 1, wherein the learning spaces are information spaces for communication and collaboration among users with compatible profiles.

5. The method of claim 1, wherein the navigation mechanism is user network centric to view the user's personalized network.

6. The method of claim 1, wherein the user centric navigation facilitates graphical view of user's owned learning space, registered learning space and pending invites.

7. The method of claim 6, wherein the user centric navigation facilitates graphical view of other learning spaces, its member details and their contributions to the learning spaces.

8. The method of claim 1, wherein the navigation system is friend's network based navigation to view common learning spaces among the users through learning spaces.

9. The method of claim 1, wherein the user can navigate through the contributions made by other users in the learning space.

10. The method of claim 1, wherein the navigation system is learning space network centric to facilitate view of similar learning spaces that exists in the community based on common metadata.
